(19) United States
(12) Patent Application Publication
(10) Pub. No.: US 2023/0137480 A1
(43) Pub. Date: May 4, 2023

(54) HYDROMETALLURGICAL METHOD FOR SIMULTANEOUSLY EXTRACTING METALS AND GYPSUM FROM THE DUST OF A STEELWORKS ELECTRIC ARC FURNACE

(71) Applicants: Julio Domingo BONELLI ARENAS, La Molina Lima (PE); Jose Enrique RAMIREZ OSTOLAZA, Santiago de Surco Lima (PE); Adolfo Fernando VERA FERNANDEZ, Santiago de Surco Lima (PE); Luis Alejandro ARAUJO FERNANDEZ, Santiago de Surco Lima (PE); Joel Omar QUINTANILLA MORALES, Santiago de Surco Lima (PE)

(72) Inventors: Julio Domingo BONELLI ARENAS, La Molina Lima (PE); Jose Enrique RAMIREZ OSTOLAZA, Santiago de Surco Lima (PE); Adolfo Fernando VERA FERNANDEZ, Santiago de Surco Lima (PE); Luis Alejandro ARAUJO FERNANDEZ, Santiago de Surco Lima (PE); Joel Omar QUINTANILLA MORALES, Santiago de Surco Lima (PE)

(21) Appl. No.: 17/905,207

(22) PCT Filed: Feb. 9, 2021
(86) PCT No.: PCT/PE2021/000002

§ 371 Date: Aug. 29, 2022

(30) Foreign Application Priority Data
Mar. 2, 2020 (PE) 000302-2020/DIN

(51) Int. Cl. C22B 9/02; C22B 7/00; C22B 3/00; C22B 11/00; C22B 26/20; C22B 1/00; C22B 9/14

(52) U.S. Cl. CPC C22B 9/02; C22B 7/002; C22B 7/006; C22B 13/045; C22B 11/044; C22B 19/26; C22B 26/20; C22B 1/005; C22B 9/14

(57) ABSTRACT

A hydrometallurgical method for simultaneously extracting zinc, lead, silver, iron and calcium from electric arc furnace dust (hazardous waste) produced by the steelmaking industry (steelworks), in the form of industrial products: zinc as zinc sulphate or zinc cathodes; lead and silver as a concentrate of lead and silver; iron as reduced elemental iron for return to the electric arc furnace; and, lastly, calcium as gypsum, without solid waste or liquid effluents being generated relates to the chemical nature of the electric arc furnace dust (complex oxides) changes to a sulfide complex, and eliminating the hazards associated with the generation of fugitive heavy-metal salts. In addition, the hydrometallurgical problem of low recovery of zinc and iron is solved. Consequently, hydrometallurgy is made easier and more environmentally friendly, as condensed water is used as a leachate, the condensed water being continuously regenerated by vacuum evaporation systems without generating effluents.

### TECHNICAL FIELD

The present disclosure pertains to the technical field of steelmaking, specifically relating to a new hydrometallurgical method for recovering valuable metals from steelmaking waste, and it more specifically relates to a new hydrometallurgical method for extracting and recovering valuable metals from electric arc furnace dust produced by the steelmaking industry (steelworks) worldwide, such as zinc, lead, silver, iron and calcium, in the form of industrial products, from treating complex oxides.

### BACKGROUND

The known electric arc furnaces used for producing steel are fed with industrial scrap, and this scrap is a complex consisting of metallic compounds from the chemical point of view, as it typically has as constituents Fe, Zn, Pb, Mg, Mn, Cl, Ca, percentagewise; Cr, Cd, Ag, P, Sn, in parts per million (ppm); and furthermore several chemical elements in parts per billion (ppb).

The average or standard chemical composition of electric arc dust is the following:

TABLE 1
Composition of electric arc furnace dust

| Element | % | Element | % | Element | ppm | Element | ppm |
|---|---|---|---|---|---|---|---|
| Fe | 18.30 | C | 0.97 | Cr | 2,378 | Ag | 102 |
| Zn | 19.50 | Si | 1.80 | Sn | 1,710 | Bi | 92 |
| Cl | 4.52 | Mg | 0.85 | P | 1,228 | V | 57 |
| Pb | 1.60 | Al | 0.43 | Ba | 898 | As | 33 |
| Na | 0.87 | S | 0.37 | Cd | 648 | Zr | 21 |
| Ca | 2.62 | Cu | 0.23 | Sb | 500 | Co | 20 |
| K | 0.85 | Ti | 0.10 | Sr | 179 | Hg | 5 |
| Mn | 1.92 | | | Ni | 145 | Mo | 5 |

Electric arc furnace dust is generated inside the electric arc furnace at temperatures higher than 1,300° C.

Depending on the geographic location, electric arc furnace dust chemical composition percentage varies, because steels produced before being converted to scrap have had various uses and various corrosion protection systems (galvanising, paints, plastics) or a component of an alloy (chromium, nickel, etc.) which allow it to have special properties, suited to each specific local need local specific. The content of zinc, which is in the ranges of 12% to 35%, essentially varies.

The generation of electric arc furnace dust has a range which varies from 11 kg to 17 kg per metric ton of steel produced, which indicates that per million metric tons of steel produced by the electric arc furnaces, between 11,000 and 17,000 annual metric tons of electric arc furnace dust are generated. The lifetimes of steelworks are very long and, for that reason, over time, this waste becomes considerable in volume, but also risky because electric arc furnace dust is considered hazardous for the environment and for human and animal health due to the presence of some toxic elements such as lead, cadmium, arsenic, mercury among others.

Existing pyrometallurgical and hydrometallurgical methods for recovering or extracting metals such as zinc, lead, silver, iron and calcium of electric arc furnace dust cannot prevent the generation of solid waste with a hazardous content, so it is not possible, with the current state of the art, to recover the aforementioned metals without preventing industrial landfills and the constant risk of environmental pollution and health hazards.

Moreover, in the current state of the art there is no pyrometallurgical method, hydrometallurgical method, or a combination of both, which recovers simultaneously and in a single method all the valuable content of zinc, lead, silver, iron and calcium from electric arc furnace dust, moreover converting the non-metallic contents of electric arc furnace dust into commercial final products, without generating solid waste or liquid effluents.

With respect to pyrometallurgical methods, the Waelz kiln process, which is the most widely used process to recover zinc from electric arc furnace dust, takes zinc to the gas phase by using a high temperature (between 1,000° C. and 1,500° C.), surpassing the boiling point of zinc, using metallurgical coal (coke) as a reducer, producing zinc oxide (ZnO).

This process does not recover all the metals, such as the iron lost in the process slag (Waelz slag). Additionally, other metals such as calcium and aluminium are lost in this slag. This process obtains only the intermediate product zinc oxide (Waelz oxide) which still needs to go through a refinery to obtain final zinc.

The Waelz kiln process, in general, has the drawback of producing intermediate metallurgical products because the zinc oxide produced requires subsequent metallurgical treatment, does not recover iron, generates slag, and uses a great deal of energy in the process. Moreover, this method is not designed to be implemented in small steelmaking plants which generate less than 20,000 metric tons of electric arc furnace dust per year.

The Waelz kiln process needs an order of magnitude of 100,000 metric tons of electric arc furnace dust per year, a volume that far exceeds the annual generation of this waste in several steelworks located in different countries, which amounts to about 30,000 metric tons per year.

Other pyrometallurgical methods similar to the Waelz kiln process, such as, for example, Primus, PIZO, ESRF, Mitsumi, electrothermal furnace, flame reactor, daido furnace; produce, in general, the same product as the Waelz kiln process, in other words, crude zinc oxide (CZO), which requires subsequent treatments such as the IS (imperial smelting) process or conventional electrodeposition methods to obtain electrolytic zinc.

In general, existing pyrometallurgical methods in the state of the art are methods that produce intermediate metallurgical products that need subsequent metallurgical methods so as to be able to obtain and use on an industrial level the generated zinc. Moreover, they do not recover iron and generate solid waste, such as slag, containing most of the non-metallic components and several hazardous metals, in addition to liquid effluents which need to be processed in treatment plants.

With respect to existing hydrometallurgical methods in the state of the art, acid leaching or caustic leaching are known, which also produce zinc oxides (ZnO) as intermediate metallurgical products which subsequently need electrodeposition methods to obtain zinc. These methods do not recover iron and use chemical agents (acids and bases) for subsequent selective zinc leaching methods.

There are also the EZINEX, ZINCEX, and RECUPAC leaching methods, which use chemicals, based on acidic chlorine, sulphuric, ammonia-based or organic chemical solutions, which are a variation of those mentioned above. Said methods, as in the preceding methods, have the same limitations of producing intermediate metallurgical products and do not allow for the simultaneous recovery of all the heavy metals (Cd, As, Sb). Moreover, they produce solid waste and liquid effluents which need to be processed in treatment plants.

The hydrometallurgical methods mentioned in the above paragraph, with respect to leaching, show advantages and drawbacks with respect to acid or alkaline leaching. While high dissolution kinetics and reagent availability are desirable, it is necessary to also deal with low selectivity, which is of high importance in electric arc furnace dust due to the presence of other chemical elements.

Due essentially to the fact that both types of leaching cannot efficiently break up ferrites (Fe₂O₃.ZnO) with chemicals in solution, which inevitably produces zinc losses in the insoluble iron and the presence of iron in zinc solutions, and moreover compromises the quality of the solutions e insoluble elements and produces a great deal of complexity with the presence of other metals present (Cd, As, Sb).

Consequently, both types of leaching do not recover the iron, and its insoluble elements constitute industrial waste; and, moreover, they are not able to recover valuable elements simultaneously (Zn, Fe, Pb, Ag), and also lack the capability to completely remove hazardous constituents (As, Sb, Cd, Hg, Co, etc.).

It should be noted that hydrometallurgical methods using sulphuric acid, hydrochloric acid, nitric acid, ammonia, sodium hydroxide, ammonium chloride, calcium chloride, as a leachate, organic compounds as extractive media, high-pressure leaching generating method waste (insoluble elements or precipitates) or liquid effluents (wastewater), is unrelated to the new method developed.

### SUMMARY

The new hydrometallurgical method developed is capable of treating any type of electric arc dust and recovers, by simultaneously extracting zinc, lead, silver, iron and calcium, in the form of industrial products; zinc as zinc sulphate or zinc cathodes; lead and silver as a concentrate of lead and silver; iron as reduced elemental iron for return to the electric arc furnace; and, lastly, calcium as gypsum.

Moreover, no solid waste or liquid effluents are generated with the new method, which is an important advantage as electric arc furnace dust is considered a hazardous waste that increases each year. Industrial metals thereby return to the industry, and the need for continuous and growing landfills for waste is eliminated, mitigating the potential risk to the environment and human and animal health.

The synergy achieved with the invented method is due to the integration of its different steps, a diagram of which is detailed in FIGS. 1 and 2, and to the efficient handling of the intermediate products being generated throughout the method.

Unlike the pyrometallurgical and hydrometallurgical methods present in the state of the art and used for treating and recovering materials from the dust of a steelworks electric arc furnace, the invented method has been developed based on the consideration that electric arc furnace dust is a mixture of complex oxides and not solid solutions such as (M1/M2)ₓO_{y}, but rather agglomerations such as M1O.M2ₓO_{y} (ferrites), particle sizes in the range of 0.17 micra to 6.76 micra, are very fine dust, have a large surface area, are agglomerated naturally in a very easy manner. The alkali and alkaline elements are in balance with the halogen elements. An important additional aspect is that the average diameter D₅₀ is 0.62 micra, which makes the powder very chemically reactive with high reaction kinetics under certain circumstances.

The dust is generated inside the electric arc furnace at temperatures higher than 1,300° C., and many of the metals present such as Zn, Pb, Cd, Co, etc., are in the gaseous state and are extracted by gas capture systems. In addition, the balance of the content of molten steel forms a liquid slag in the presence of Fe, Ca, Si, etc. During the blowing process inside the furnace, fine particles of slag and even steel (very fine droplets) are driven through the gas capture systems.

Inside the capture tubes and pipelines, the whole (gases and particles) is cooled on the way, due to the drop in temperature to about 60° C., and all the metallic gases pass to the solid state, the integrity of which forms what is referred to as electric arc furnace dust.

A fundamental aspect, due to the genesis of the formation thereof inside the electric arc furnace, which is of an oxidising condition due to the addition of gaseous oxygen to the furnace, is that this dust is made up of complex oxides of the forms MₓO_{y}/MO.MₓO_{y}, where M is the metal (Fe, Pb, Zn, etc.) and O is oxygen.

The alkalis, alkalines and halogens present in the scrap are added to this complex, and when they are cooled, they are present in their stable thermodynamic forms under normal conditions. In general, particles having a larger diameter contain more iron.

### Steps of the Method

The new hydrometallurgical method developed for the treatment of electric arc furnace dust are shown schematically in FIG. 1, and it comprises the following steps described in detail below:

### 1. Conditioning:

The purpose of this step is to homogenise and identify the chemical composition of electric arc furnace dust, in other words, the content of zinc, iron, Cl, Pb, Ca, Ag, Cd and Hg in order to know the valuable metals present, of the elements of risk for metallurgical control and balance in the method.

Insofar as electric arc furnace dust, in dry conditions, is very fine, it tends to form gray layers of different sizes, so it is necessary to homogenise them, this action being performed in an encapsulated mixture which produces the homogeneous mixture making up the homogeneous electric arc dust stock, which is stored in encapsulated hoppers preventing the leakage thereof.

The homogeneous electric arc dust stock will enter the method after the chemical analysis thereof has been performed.

The most important aspect is to determine the zinc (17.50% to 19.50%) and iron (17.26% to 28.26%) grade, in addition to knowing with certainty the content of Cl, Pb, Ca, Ag, Cd and Hg. Therefore, this provides knowledge with the highest possible level of certainty of the valuable metals and elements of risk for metallurgical control and balance in the method.

### 2. Scrubbing:

The electric arc dust (hereinafter, dust) contains halogens (CI) and, consequently, alkalis and alkalines, which elements must be removed from the oxide complex because they are detrimental to the following steps of the method.

For this purpose, the homogenised dust is transported from the encapsulated hoppers to the scrubbing tanks, which are encapsulated tanks so as to prevent the possibility of dust leaking and to send the water vapours to the evaporation and condensation systems, having with a suction system which allows operating at a negative a pressure, 0.97 atmospheres.

The water comes from the condensed water feed system, has an absence of dissolved gases and salts, enters at 80° C., with a mass ratio of 4 to 1. The absence of salts and gases dissolved in the water and the operating temperature confer to the water better properties for dissolving the complexes of Cl, Na, K, Mg, Ca, Ba present in the electric arc furnace dust.

The scrubbing tanks maintain a constant suspension by means of mechanical agitation for 15 minutes in the first part of the scrubbing, and the suspension seeks contact among all the dust particles and the hot condensed water. This phase produces a liquid loaded with the already mentioned soluble complexes, which is sent to a liquid purification unit (DETOX) of the method by means of the liquid/pulp decanting system. The pulp enters a second scrubbing time of 10 minutes, with water having the same characteristics of the method, and the objective is to force a second dissolution of halogens, alkalis, alkalines. Similarly, the decanting system sends the liquid to the liquid purification system, and the previously filtered solids pass to the following phase.

There is obtained a reduction of Cl of more than 95%, consequently obtaining very high reductions of Na, Mg, Ba. A reduction of 17% by weight of the initial content of dust is obtained in general.

Due to the corrosive nature of the liquids of this method, the agitation systems of the tanks and the line pipes have an anticorrosive coating. The liquid and pulp impulsion systems are carried out by means of peristaltic pumps.

Accordingly, the filtered solids have, on average, 10% humidity, are insoluble solids, and are almost entirely made up of complex metal oxides.

### 3. Extensive Sulphation:

The solid from the scrubbing phase enters the extensive sulphation phase. This consists of changing the chemical nature of the oxides to that of simple and complex sulphates in total form. In other words, going from a complex insoluble oxide integrity to a sulphate integrity. This step does not exist in any method present in the state of the art used for recovering metals from electric arc furnace dust, it consists of adding sulphuric acid to the solids of the scrubbing phase for the purpose of changing the chemical nature of the electric arc furnace dust from complex oxide compounds to a group of simple and complex reaction sulphates.

To generate this reaction, the mixture, by weight, of one part dust to 0.87 parts pure acid is performed in a reactor specially designed for this phase. The reactor is a continuous mixing reactor and a paste is generated in same; the reaction is exothermic and carried out in a range of 120° C. to 150° C., to which there is added water at 80° C. from the condensed water generation system, only in order to replace the water losses due to evaporation in the reaction and maintain the plastic condition of the paste.

This phase lasts for 20 minutes, and the paste generated is very dark, homogeneous and hot; it is important that it is mixed vigorously and constantly, because the paste formed is very viscous, and the complete chemical sulphation reaction and depletion of sulphuric acid must be obtained. This is a very important aspect since the method consumes all the acid, generating no free acid solutions in the method.

This phase does not produce liquids in any form and produces water vapour in a very limited form and very little acid mist, where these vapours and gases go to SO₃ recovery systems and re-enter the sulphuric acid stock system of the closed circuit method.

Essentially, in this step, the oxide molecules are broken down, replacing the oxygen in the molecules with the typical compound SO₄, which is an important aspect of the method and radically different from all existing methods, because the treatment of complex oxides is inefficient in the leaching methods with chemical reagents.

In this step, the chemical nature of the electric arc furnace dust changes completely, going from a complex oxide compound to a group of sulphates from a simple and complete reaction as the method continues until the reaction ends (complete consumption of the reagent). This is a turning point in the state of the art, because hereinafter, the nature of the entire method is different from all that exists because the material in the method has another chemical nature, that is, it is a sulphated mixture of electric arc furnace dust.

### 4. Drying:

The sulphated mixture of electric arc furnace dust is dried in the same sulphation reactor, which continues to operate under continuous mixing, with the temperature of the reactor increasing to 200° C., and the paste proceeds to dry, losing all the water by evaporation, forming dark grey agglomerated crystals.

This step lasts for about 10 minutes and has two important objectives: first, to remove water in order to prevent thermal shock in the next step, and second, to ensure the complete reaction of the new sulfide complex.

The reactor is still encapsulated. It is theoretically possible for a minimum amount of SO₃ to be present, the reactor being in line with of SO₃ capture and gas cleaning systems.

### 5. Thermolysis:

The purpose of this step is to keep a part of the complex soluble (essentially zinc as zinc sulphate), and one part is converted to an insoluble part (essentially iron as hematite).

After the drying phase, the temperature of the reactor is increased to a working of 680° C. to 720° C., depending on the concentration of Zn, Fe, Pb, in the paste. The mechanical mixing is kept constant such that the crystals formed in the drying phase can increase the temperature homogeneously. The reaction time is about 2 hours.

In this phase, the thermolysis reaction (thermal decomposition) of iron sulphate takes place as the main reaction, which produces the formation of hematite (Fe₂O₃), with the corresponding generation of SO₂ and O₂, according to the reaction:

4FeSO₄=2Fe₂O₃+O₂+4SO₂.

The reaction is carried out at normal pressure. The generated gases are sent to the gas cleaning and SO₂ capture system, which is added to the sulphuric acid stock of the method. In addition to the thermal decomposition reaction of the iron, where the oxides with lower formation energy in relation to iron are also decomposed, as in the case of Pb, Ag, Si, Mn, P, Sn, Cd, Ni, Bi, etc.

The group of compounds present in majority form that do not decompose are of a higher energy of hematite formation, such as Zn, Ca and other minority compounds that maintain their new sulphate nature.

What has been achieved at this stage is of major importance in the method, that is, the hematite formed and all the additional oxides formed are insoluble, while, in contrast, zinc in the form of sulphate has a high solubility, which is sent to an encapsulated hopper where it is cooled to 70° C.

### 6. Aqueous Leaching:

The purpose of this step is to obtain two new complexes, one being liquid with a large amount of zinc and the other one being insoluble and essentially made up of hematite, gypsum and lead oxides plus other minor oxides.

The leaching time is about 1 hour to 1 hour and 30 minutes, is carried out in encapsulated tanks with an evaporation water vapour extraction system, and leaching is carried out at 260 RPM and 70° C. The tanks have an anticorrosive coating, and the solutions are moved with peristaltic pumps.

The solid/liquid volumetric ratio is 1 to 3.6, where the water comes from the condensed water system and is a countercurrent system, such that the solids are solubilised and progressively lose zinc, whereas the solution progressively increases in terms of the content of zinc and, to a lesser extent, in terms of the content of Mn and Ca.

The leachate is condensed water, without the addition of any type of reactive chemical, where the objective of this phase is not to leave soluble elements in the solid essentially made up of hematite, and for this reason leaching is performed with the addition of water in order to replace water losses due to evaporation.

The aqueous leaching phase is very efficient and produces the very efficient extraction of zinc, producing a solution which, on average, tests 56 g of Zn per litre, with a small amount of other components, where the solids are, for the most part, hematite and other metal oxides such as calcium and lead oxides.

The solids are very fine, and a high-pressure pump filtration system is necessary for an efficient separation of the leached solution.

At this point, there are two new complexes, one being liquid with a large amount of zinc and the other one essentially made up of hematite, gypsum and lead oxides plus other minor oxides.

The solids are sent to the flotation method, and the liquids are sent to the evaporation-crystallisation/electrodeposition system, where it is essential to keep the temperature of the liquid flow at 70° C., which is moved by peristaltic impulse.

### 7. Zinc Recovery:

The purpose of this step is to obtain zinc, in the desired form, as the final product, preferably as zinc sulphate or as zinc cathodes. If necessary, it is possible to purify the solution with the addition of zinc dust, and the obtained sludge is sent to the sludge system.

In a first desired form, shown in FIG. 1, zinc sulphate is produced, and the liquid containing essentially zinc is previously vacuum-evaporated, this operation being performed in a conventional vacuum evaporator wherein the volume of water is reduced by 96%, sending the water vapour to the condensation system, from where the water is recycled to the various water needs of the method.

The evaporation method prevents the metal and non-metal ions from leaving the solution, and the water vapours do not contain ions. As the volume of liquid water is reduced, the concentration of zinc increases.

For producing zinc sulphate, which gives the highest added value, an oversaturated solution of 1,800 g Zn/L is produced, which solution enters the crystallisation method in steps and in countercurrent in the conventional encapsulated reactor with a temperature delta of 40° C. Crystallisation in steps is one of the most efficient forms of purification available. The first crystals are very pure, and the last crystals that are formed are less pure. This finally produces the crystalliser in a mixture of all these crystals, yielding a typical composition shown in Table 4. Zinc sulphate is widely used in the mining industry as a flotation reagent for polymetallic ores.

In a second desired form, to obtain zinc cathodes shown in FIG. 2, a subsaturated solution is produced with 60 grams per litre of zinc for the zinc electrodeposition method, where high quality zinc cathodes with the consistency of agglomerated fine dust are obtained by means of the conventional method widely known in the metallurgical industry (zinc cathode electrodeposition method from sulphuric solutions). In this case, the liquids are recycled by vacuum evaporation, and the anode sludge is added to the concentrate of lead-silver. This product returns the metal to the industrial circuit.

### 8. Flotation:

This purpose of this method is to separate the hematite from lead oxides and various metal oxides present in a very small amount, for example, cadmium, nickel, arsenic.

The solids coming from the leaching phase are insoluble under normal conditions, with a majority composition of hematite and with the minority presence of lead oxides, calcium sulphate (gypsum) and an important presence of silver; By using the flotation properties of the lead and silver oxides in the presence of hematite (absence of sulfides), foam flotation operations produce excellent separation, producing an ore concentrate of commercial-quality lead-silver the typical composition of which is reported in Table 2. This oxide ore flotation method also concentrates many of the heavy metals. However, it additionally cleans the hematite of this content.

Due to the ultrafine nature of the particles of all the components, it is a virtually artisanal operation that takes about two hours, the time needed to favour the entrainment of lead oxides and heavy metal oxides. The flotation reagents used are those from the family of sodium sulfide (Na2S), in the presence of sodium carbonate and sodium silicate, with the use of xanthate and pine oil. Additionally, the hematite needs starch as a depressant. The composition of the typical concentrate obtained is shown in Table 2 below.

TABLE 2
Typical product composition

| ZnSO4•7H2O | | | | CaSO4•2H2O | | CC Pb Ag | |
|---|---|---|---|---|---|---|---|
| Zinc sulphate | | Fe° | | Calcium sulphate | | Concentrate of | |
| heptahydrate | | Reduced iron | | dihydrate | | lead-silver | |
| Zn | 22.61% | Fe | 93.417% | CaSO4 | 52.26% | Pb | 52.06% |
| S | 11.01% | C | 3.921% | SiO2 | 18.31% | Ag | 81.33 |
| | | | | | | | Oz/MT |
| ZnSO4 | 55.47% | Si | 1.266% | Fe2O3 | 7.28% | Zn | 4.88% |
| Cl | 0.71% | Mn | 0.669% | ZnO | 2.21% | Cu | 0.59% |
| Fe | 71 ppm | P | 0.049% | PbO | 1.05% | S | 3.52% |
| Hg | Tr ppm | S | 0.056% | HMe | 0.17% | in- | 5.11% |
| | | | | | | soluble | |
| Pb | Tr ppm | | | | | SiO2 | 1.95% |
| H Me | 2 ppm | | | | | Ca | 0.68% |
| | | | | | | Mn | 0.51% |
| | | | | | | Bi | 0.12% |
| | | | | | | Sb | 0.26% |
| | | | | | | As | 0.08% |
| | | | | | | Mg | 0.17% |
| | | | | | | Al | 0.41% |
| | | | | | | P | 0.19% |
| | | | | | | Cd | 117 ppm |
| | | | | | | Ba | 437 ppm |
| | | | | | | Sn | 370 ppm |

### 9. Magnetic Separation:

The purpose of this step is to separate gypsum from the hematite.

The hematite still contains gypsum (CaSO4.2H2O); due to the need to use reduced hematite (FeO) as electric arc furnace feed material, it is necessary to remove the gypsum, for which magnetic separation is used, taking advantage of the wide delta of magnetic susceptibility existing between hematite (35×10³ SI) and gypsum (−0.11×10³ SI).

However, magnetic separation is also a unit operation which requires a great deal of supervision so as to prevent the entrainment of gypsum fines in the hematite, and it is done at low speeds between 0.7 feet/min and 0.8 feet/min of the magnetic separator and at a magnetic flux density between 19,000 gauss and 21,000 gauss;

This operation uses magnetic separation steps from lower to higher flux density, obtaining pre-concentrates of hematite which are subsequently mixed in order to be sent to the hematite reduction method in their conventional form to produce reduced iron, which is agglomerated due to its fine nature to finally be returned to the electric arc furnace (EAF).

10. SO₃/SO₂ Recovery System:

The method has a conventional catalytic system for SO₃/SO2 recovery, capturing gases in diluted solutions of H2SO4 (at 70%) in the presence of catalysts, the capture solution is added to the sulphuric acid stock of the method. The commercial system has forced air heat sinks and is encapsulated.

### 11. Gas Scrubbing System:

The gases of the system are essentially air, O₂ and CO₂; however, given the ultrafine nature of the dust, a small portion of said dust is entrained by the streams of said gases, which is why it is necessary to have a gas scrubbing system that retains the particles.

The environmental efficiency of the method with respect to the gaseous phase depends on the efficiency of this system, whereby it is a countercurrent cleaning system forcing the gas and particles to pass through water mist and sprays under countercurrent (1.2 m³ per m³ of gas), repeatedly, with several scrubbing columns and coils, The gas passes through ultrafine filters before leaving the method so as to ensure that there is no loss of solids.

The solids are captured as sludge which is, in essence, electric arc furnace dust or calcine from the thermolysis method; this sludge is sent to the sludge collection system, and the liquid from the gas scrubbing method is sent to the liquid purification unit by impulsion by peristaltic pumps.

### 12. Sludge Recovery (Collector):

This step prevents the loss of dust because of its ultrafine nature and consists of handling sludge formed by these particles. All the reactors and flow systems are encapsulated and capture fugitive particles which, because the various systems are in closed circuit, produce sludge. The latter is sent to this step of the method.

The water vapour also entrains a minimum portion of particles, which are captured in the vacuum evaporation system and sent to the sludge collector.

This sludge is filtered by two twin pumps, the first with a 5-micron membrane and the second with a 2.5-micron membrane; said membranes are made of phenolic resin. This operation is carried out at 3.5 bar of pressure.

The obtained solids are added to the concentrate of lead-silver, thereby preventing the significant generation of waste. This operation does not affect the quality of the concentrate.

The resulting liquid has an ionic content and is therefore sent to the liquid purification system.

### 13. Liquid Purification—Detox:

This step consists of a unit which receives liquid flows containing anions, cations, suspension of ultrafine solid particles from the dust scrubbing method, gas scrubbing method, sludge collector and liquid flows of the flotation phase (concentrate and tailings) and eventually from the cleaning and maintenance method for any reactor.

It consists of the water decontamination method, and consists of a chemical ion separation system, high-pressure membrane filtration, vacuum evaporation, chemical precipitation, returning the clean water to the industrial condensed water method, crystallising the contaminants. It is equipped with technology available on the market.

The solids are integrated (precipitates, sludge and crystals), homogenised and added to the concentrate of lead-silver for the respective marketing thereof.

### Other Aspects of the Method

A particular feature of the present method is that it is designed for the steelmaking operator, as the new method can be installed in the same steelmaking plant, very close to the electric arc furnace, and can even share synergies with the steel plant as it is encapsulated and not susceptible to experiencing disruptions due to the atmosphere of the operations, and the operations of the method do not disrupt the operations of the steel plant.

Due to the way the chemical nature of the complex oxides (electric arc furnace dust) changes to a sulfide complex, the hazards associated with the generation of fugitive cadmium and hexavalent chromium salts are eliminated, and the hydrometallurgical problem of low zinc and iron recovery is solved. Consequently, hydrometallurgy is made easier and more environmentally friendly, as condensed water is used as a leachate, the condensed water being continuously regenerated by vacuum evaporation systems without generating effluents. The method consumes a minimum of water (only the zinc sulphate hydration water, the calcium sulphate hydration water, the humidity of the concentrate of lead-silver and evaporation are lost) which is added as a replacement.

No metals in the form of gas or molten solutions or elements are handled, and the method uses in its reactions solids, liquids and ions that are selectively separated. The method defines the manner of extracting hazardous metals (Pb, Cd, As, Co, etc.), and converting them to a final metallurgical product (concentrate of Pb—Ag), where this aspect is an important contribution as it sends heavy metals back to the lead treatment smelters, which are the most suitable circuits and methods for treating and recovering heavy or toxic metals.

The sludge generated in the various steps (gas cleaning, return water filtration sludge, air cleaning dust) are mixed with the concentrate of lead, adding them to this product. The method does not generate solid waste. Moreover, if necessary, this concentrate can be mixed with concentrates of higher grade lead in order to fulfil the commercial grades required by the industry.

The method emits only CO₂, as a result of the need to produce heat for the thermolysis reactor, due to the use of NGV/LPG to heat the reactor; the combustion gases are also used for the purification systems and maintenance of the reaction temperatures of the various solutions of the method and the evaporation systems at temperatures above normal conditions and negative pressure. It should be mentioned that electric systems such as motors, valves, actuators, sensors, lighting and contingency systems operate based on electrical energy (440V, 60 Hz) supplied by the public system; it furthermore has a generator set which, in the case of contingency, provides energy for the emergency system (safe shutdown of operations) and lighting.

One aspect of special attention is that all reactors and solution delivery systems are coated with resin and polymer films with high corrosion resistance and working temperature ranges of 100° C. on average.

Gas delivery systems are developed with conventional systems for corrosive hot gas flows in the metallurgical industry (sulphide smelters and steelworks).

The method, on average, is as shown in Table 3, has the following mass behaviour with respect to the products which are obtained from 1 MT of electric arc furnace dust.

TABLE 3
Unit mass table

| Furnace | | ZnSO4• | | CaSO4• | CC |
|---|---|---|---|---|---|
| dust | A | 7H2O | Fe | 2H2O | Pb − Ag |
| 1000 | Kg | 838.01 | 182.84 | 209.19 | 26.79 |
| 40 | MT | 33.52 | 7.31 | 8.37 | 1.07 |

The positive weight differences are due to the addition of sulphur and the hydration water; 7H₂O in the case of zinc sulphate and 2H₂O in the case of calcium sulphate.

With respect to the metallurgical recoveries of the valuable elements of the method, which are essentially zinc, iron, lead/silver, these can be seen in Table 4.

TABLE 4
Metallurgical recovery of economic metals

| | ZnSO4• | | CC | CaSO4• | |
|---|---|---|---|---|---|
| Metal | 7H2O | Fe° | Pb − Ag | 2H2O | Total |
| % Zinc | 97.17 | | 0.67 | 1.90 | 99.74 |
| % Iron | | 93.34 | 5.83 | 0.79 | 99.95 |
| % Lead | | | 87.15 | 12.74 | 99.90 |
| % Silver | | | 66.43 | 33.50 | 99.93 |

The payable zinc content is, on average, 97%, being contained in zinc sulphate, as the content present in the concentrate of lead-silver and in gypsum are not payable.

The concentrate of lead and silver is, in general, a concentrate considered dirty or borderline, because it receives sludge from the various purification or cleaning methods. The payable section is 87% for lead and 66% for silver, with respect to the content at the head, analysed in Table 1 and the quality reported in Table 2.

With respect to the reduced iron as the final step of the reduction of high-purity hematite, the method recovers 93% of the total, and this product returns to the electric arc furnace. The difference of the iron is, firstly, in the gypsum due essentially to the fineness of the particles which have a strip entrainment effect, and, secondly, in the concentrate of lead-silver.

The gypsum formed in the method has good holding properties for the mining industry, which is the final destination of the product because it contains a portion of metals and the balance of silver.

### BRIEF DESCRIPTION OF THE DRAWINGS

FIG. 1 is a block flow diagram illustrating a detailed embodiment of the invented method, because evaporation offers the flexibility of producing an oversaturated solution of zinc, from which zinc sulphate is produced in crystallisation.

FIG. 2 is a flow diagram which shows a second additional embodiment of the invented method, as evaporation offers the flexibility of obtaining a subsaturated sulfuric solution in the order of 60 grams per litre, which allows for the use of the normal electrodeposition (EW) method from which zinc cathodes are obtained.

### DETAILED DESCRIPTION OF THE DRAWINGS

Steelmaking companies using electric arc furnaces for producing steels generally have a production which is, on average, a million tons of steel (1,000,000 MT) per year.

As previously mentioned, per ton of steel produced, 11 kg to 17 kg of electric arc furnace dust are generated, with a content of zinc from 12% to 35%.

Hence, on average, per million MT of steel produced annually, about 12,000 annual tons of electric arc furnace dust are produced.

In view of the attached figures, and according to the numbering of the steps of the method used, two non-limiting exemplary embodiments of the present disclosure can be seen therein, with the understanding that the description must be considered as an example of the principles of the disclosure and does not intend to limit the broad scope of protection of the hydrometallurgical method for simultaneously extracting metals and gypsum from the dust of a steelworks electric arc furnace.

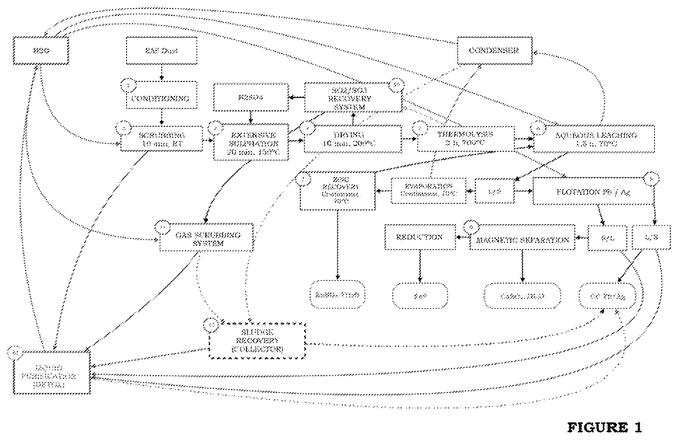

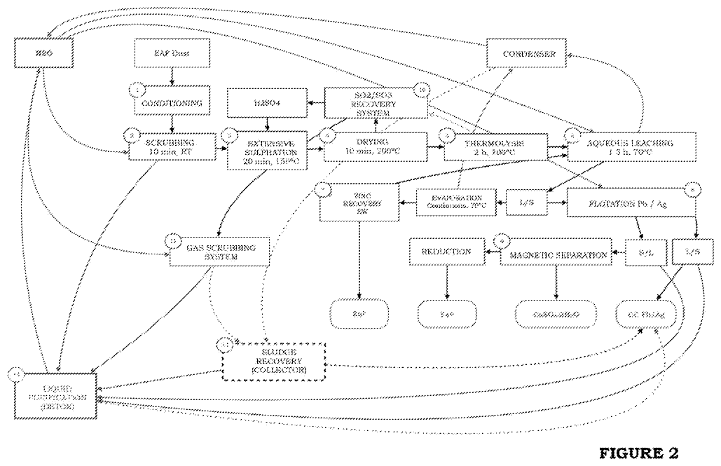

Next, a detail for a typical operation of 40 DMT of electric arc furnace dust based on the described methods and FIGS. 1 and 2 will be described, where the operating detail is the following:
1. The dust is conditioned without adding any type of substance or liquid, and grades are determined for: Zn, Fe, Pb, Ag, Ca and Cl as follows:

| | | |
|---|---|---|
| Zn | 19.50% | Average content of the |
| | | blend of fresh and landfill dust. |
| Iron | 18.30% | Average content of the |
| | | blend of fresh and landfill dust. |
| Lead | 1.60% | Average content of the |
| | | blend of fresh and landfill dust. |
| Silver | 3.28 | Average content of the |
| | Oz/MT | blend of fresh and landfill dust. |
| Calcium | 2.62% | Average content of the |
| | | blend of fresh and landfill dust. |
| Other metals | 0.80% | Sum of the content in ppm |
| (PPm) | | Cr, Sn, P, Ba, Cd, Sb, Sr, Ni, etc. |
| Chlorine | 4.50% | Average content of the |
| | | blend of fresh and landfill dust. |

2. 40 MT of a blend of dust are scrubbed in a reactor with 30.23 m³ of condensed water from the evaporation method at 80° C., which method is carried out at 0.97 atmospheres. 11.70% of the weight of the dust is removed by removing Cl, Na, K, Mg, Ca, Ba, etc., and the solution is sent to DETOX to recover the salts.
3. The solid part from the scrubbing step enters the extensive sulphation phase, and 35.32 MT of a blend of dust are treated, raising the grade thereof 23.45% due to the weight reduction. 22.96 MT of H₂SO₄ are added until the reaction ends and the reagent is completely consumed (complete stoichiometry), producing an exothermic reaction at 130° C., and 11.48 m³ of condensed water from the evaporation method is added at 80° C. to replace the water that evaporates and to prevent thermal shock.
4. In the same reactor, the temperature is increased to 200° C., producing the drying of 47.95 MT of dust paste, a weight that is increased due to the addition of S (SO₄), changing the chemical nature of the dust.
5. After the drying phase or step, 48.55 MT of dust is obtained due to the change in nature of iron from Fe₂O₃ to FeSO₄, and it is subjected to thermolysis, with the temperature of the reactor increasing to 700° C., depending on the concentration of Zn, Fe, Pb, in the paste. The mechanical mixing is kept constant such that the crystals formed in the drying phase can increase the temperature homogeneously, the reaction time being from 1.8 hours to 2.10 hours.
6. The solids (dust) obtained from the thermolysis step are subjected to aqueous leaching in encapsulated tanks with 131 m³ of condensed water coming from the evaporation method at 80° C., in a solid/liquid volumetric ratio of 1 to 3.6, without adding any type of reactive chemical, producing an efficient extraction of zinc, obtaining a solution containing on average 56 g of zinc per litre and an amount of solids, mostly hematite and calcium and lead metal oxides. At this point, there are two new complexes, one being liquid with a large amount of Zn and the other one made up of hematite, gypsum, and essentially lead oxides. The solids are very fine, so they are filtered by means of high-pressure pumps, obtaining 28.65 MT of solid cake, which are sent to the flotation method, and the liquids are sent to the method for recovering zinc (evaporation-crystallisation/electrodeposition). The leaching is performed for a time of 1 hour to 1 hour and 30 minutes, and the flow temperature must be kept at 70° C., said flow being moved by peristaltic impulse at 260 RPM.
7. From the liquid zinc complex obtained in the leaching step, depending on the form of zinc to be obtained as a final product, said zinc is recovered in two forms: a first form as zinc sulphate and a second form as zinc cathodes. In the first desired form, shown in FIG. 1, the liquid containing essentially zinc is previously vacuum-evaporated, this operation being performed in a conventional vacuum evaporator, wherein the volume of water is reduced by 96%, in the present case 126.89 m³ of water being evaporated, sending the water vapour to the condensation system, from where the water is recycled to the various water needs of the method.
   The evaporation method prevents the metal and non-metal ions from leaving the solution, and the water vapours do not contain ions. As the volume of liquid water is reduced, the concentration of zinc increases.
   To obtain zinc sulphate, which gives the highest added value, 4.11 m³ of oversaturated solution of Zn containing 1,800 g Zn/L is produced, which solution enters the crystallisation method in steps and in countercurrent in a conventional encapsulated reactor with a temperature delta of 40° C., obtaining 33.52 MT of ZnSO₄.7H₂O with an average % of commercial grade Zn of 22.62%, producing an increase in weight due to the hydration water.
   The first crystals are very pure, and the last crystals are less pure. This finally produces the crystalliser in a mixture of all these crystals, yielding a typical composition shown in Table 4.
   In a second desired form for Zn recovery in the form of cathodes, shown in FIG. 2, a subsaturated solution is produced containing 60 grams per litre of zinc for the zinc electrodeposition method, by means of the conventional method widely known in the metallurgical industry (zinc cathode electrodeposition method from sulphuric solutions), obtaining 7.55 MT of zinc cathodes with a purity of 98%. In this case, the liquids are recycled by vacuum evaporation, and the anode sludge is added to the concentrate of lead-silver.
8. The 28.65 MT of cake (dust solids) from the leaching step, which are insoluble under normal conditions, are subjected to a flotation method for a period of two hours for the purpose of separating the hematite that is present mostly from lead oxides, calcium sulphate (gypsum) and silver.
   Due to the ultrafine nature of the particles of all the components, the flotation reagents used are those from the family of sodium sulfide (Na₂S), in the presence of sodium carbonate and sodium silicate, with the use of xanthate and pine oil. Additionally, the hematite needs starch as a depressant, which produce an excellent separation of an ore concentrate of commercial-quality lead-silver the typical composition of which is reported in Table 2. In the present example, 1.07 MT of concentrate of lead-silver is obtained, with a content of additional heavy metals, and 27.58 MT of tailings containing Fe₂O₃, CaSO₄, SiO₂ and other minority components.
9. The 27.58 MT of tailings from the flotation step enter three in-line magnetic separators with a magnetic flux density between 19,000 gauss and 21,000 gauss, for the purpose of separating the gypsum from the hematite. This operation is performed at low speeds between 0.7 feet/min and 0.8 feet/min to prevent the entrainment of gypsum fines, and from a lower to higher flux density. This step obtains 20.92 MT of concentrate of hematite and 8.37 MT of gypsum (CaSO₄.2H₂O), producing an increase in weight due to the hydration water (2H₂O).
10. The gases which are produced in the different steps of the method are recovered in order to prevent them from being released into the environment through an encapsulated conventional catalytic system with forced air heat sinks for SO₃/SO₂ recovery, capturing the gases and acid mist solutions in diluted solutions of H₂SO₄ (al 70%) in the presence of catalysts, and the capture solution is added to the sulphuric acid stock of the method. In an exemplary embodiment, 8.40 MT of SO₂ are recovered and recycled.
11. The gases and streams of air generated in the various areas of the method are sent to a liquid purification system for the purpose of making the method efficient and recovering a small portion of dust which is entrained by said gases. The cleaning system used is a countercurrent system, forcing the gas and particles to pass through water mist and sprays under countercurrent (1.2 m³ per m³ of gas), repeatedly, with several scrubbing columns and coils, The gas passes through ultrafine filters before leaving the method so as to ensure that there is no loss of solids. In the present exemplary embodiment, 2 MT of method gases (O₂ plus particles) are cleaned by means of commercial reactors, and the solids are captured as sludge which is, in essence, electric arc furnace dust or calcine from the thermolysis method, this sludge being sent to the sludge collection system, and the liquid from the gas scrubbing method is sent to the liquid purification unit (DETOX) by impulsion by peristaltic pumps.
12. The sludge generated in the various areas of the method is recovered in a sludge collector for the purpose of preventing the loss of dust due to its ultrafine nature. In the present exemplary embodiment, 120 Kg of sludge from the entire method are filtered at 3.5 bar in two twin pumps, the first with a 5-micron membrane and the second with 2.5-micron membrane. The solids obtained are added to the concentrate of lead/silver, and the resulting liquid having an ionic contained is sent to the solution purification system.
13. The liquid flows containing anions, cations, suspension of ultrafine solid particles from the dust scrubbing method, gas scrubbing method, sludge collector and the liquid flows from the flotation phase (concentrate and tailings) and eventually from the cleaning and maintenance method for any reactor are sent to a liquid purification unit for the purpose of being subjected to a water decontamination method which uses technology available on the market, consisting of a chemical ion separation system, high-pressure membrane filtration, vacuum evaporation, returning the clean water to the industrial condensed water method, crystallising the contaminants, and the solids are integrated (precipitates, sludge and crystals), homogenised and added in a suitable manner to the concentrate of lead-silver for the respective marketing thereof.

In the exemplary embodiment, 200 m3/day of liquids are purified.

Table 5 shows the specification and balance of products of the method for a typical application of 40 TMD of electric arc dust.

TABLE 5
General balance of the method
40 MT dust produce:

| | | | | CaSO4•2H2O | | | |
|---|---|---|---|---|---|---|---|
| ZnSO4•7H2O | | | | Calcium | | CC Pb Ag | |
| Zinc sulphate | | Fe° | | sulphate | | Concentrate of lead- | |
| heptahydrate | | Reduced iron | | dihydrate | | silver | |
| MT | | MT | | MT | | MT | |
| 33.52 | | 7.31 | | 8.37 | | 1.07 | |
| Zn | 22.61% | Fe | 93.417% | CaSO4 | 52.26% | Pb | 52.06% |
| S | 11.01% | C | 3.921% | SiO2 | 18.31% | Ag | 81.33 |
| | | | | | | | Oz/ |
| | | | | | | | MT |
| ZnSO4 | 55.47% | Si | 1.266% | Fe2O3 | 7.28% | Zn | 4.88% |
| Cl | 0.71% | Mn | 0.669% | ZnO | 2.21% | Cu | 0.59% |
| Fe | 71 ppm | P | 0.049% | PbO | 1.05% | S | 3.52% |
| Hg | Tr ppm | S | 0.056% | H Me | 0.17% | in- | 5.11% |
| | | | | | | soluble | |
| Pb | Tr ppm | | | | | SiO | 21.95% |
| H Me | 2 ppm | | | | | Ca | 0.68% |
| | | | | | | Mn | 0.51% |
| | | | | | | Bi | 0.12% |
| | | | | | | Sb | 0.26% |
| | | | | | | As | 0.08% |
| | | | | | | Mg | 0.17% |
| | | | | | | Al | 0.41% |
| | | | | | | P | 0.19% |
| | | | | | | Cd | 117 ppm |
| | | | | | | Ba | 437 ppm |
| | | | | | | Sn | 370 ppm |

1. A hydrometallurgical method for extracting metals and gypsum from any type of dust of a steelworks electric arc furnace, wherein it recovers, by simultaneously extracting, zinc, lead, silver, iron and calcium, in the form of industrial products; zinc as zinc sulphate or zinc cathodes; lead and silver as a concentrate of lead and silver; iron as reduced elemental iron for return to the electric arc furnace; and, lastly, calcium as gypsum, the method including the following steps:
1) conditioning the electric arc dust by homogenizing and identifying the chemical composition of the dust in terms of the content of Zn, He, Cl, Pb, Ca, Ag, Cd and Hg, to know the grade of valuable metals present and of the elements of risk for metallurgical control and balance in the method, this action being performed in an encapsulated mixture which produces the homogeneous mixture, constituting the homogeneous electric arc dust stock which is stored in encapsulated hoppers, which will enter the method after the respective chemical analysis has been performed;
2) scrubbing the dust from step 1) with water, where the dust contains halogens and, consequently, alkalis and alkalines, elements which must be removed from the oxide complex because they are detrimental to the following steps of the method, for which the homogenizsed dust is transported from the encapsulated hoppers to the scrubbing tanks, the water comes from the condensed water feed system having an absence of dissolved gases and salts and enters at the temperature of 80° C. with a mass ratio of 3 to 1; the scrubbing tanks maintain a constant suspension by mechanical agitation for 15 minutes in the first part of the scrubbing, producing a liquid loaded with soluble complexes of Cl, Na, K, Mg, Ca, Ba, which is sent to the liquid purification unit of the method by the liquid/pulp decanting system; the pulp enters a second scrubbing time of 10 minutes, with water of the same characteristics of the method so as to force a second dissolution of halogens, alkalis, alkalines, and, similarly, the decanting system sends the liquid to the liquid purification system, and the previously filtered solids pass to the following step;
3) extensive sulphation by adding sulphuric acid to the solids of the scrubbing phase for the purpose of changing the chemical nature of the electric arc furnace dust from complex oxide compounds to a group of simple and complex reaction sulphates; to generate this reaction, one part dust to 0.87 parts pure acid is mixed by weight in a continuous mixing reactor specially designed for this phase, generating a paste, the reaction is exothermic and carried out in a range of 120° C. to 150° C., to which there is added water at 80° C. from the condensed water generation system, in order to replace the water losses due to evaporation in the reaction and maintain the plastic condition of the paste;
4) drying by drying the sulphated mixture of electric arc furnace dust in the same sulphation reactor, which continues to operate under continuous mixing, with the temperature of the reactor increasing to 200° C., the paste proceeds to dry, losing all the water by evaporation, forming dark grey agglomerated crystals;
5) thermolysis or thermal decomposition, where one part of the complex is converted to a soluble part (essentially zinc) and one part is converted to an insoluble part (essentially iron), and after the drying phase, the temperature of the reactor increasing to a working range of 680° C. to 720° C., depending on the concentration of Zn, Fe, Pb, in the paste, and the mechanical mixing is kept constant such that the crystals formed in the drying phase can increase the temperature homogeneously, the reaction time being 2 hours.
6) aqueous leaching, where two new complexes are obtained in this step, one being liquid with a large amount of zinc and the other one being insoluble and essentially made up of hematite, gypsum and lead oxides plus other minor oxides, being carried out at 260 RPM and 70° C. in encapsulated tanks with an evaporation water vapour extraction system and in a solid/liquid ratio of 1 to 3.6, the leaching time being between 1 hour and 1 hour and 30 minutes;
7) zinc recovery, where zinc is obtained in this step according to two preferred forms to be obtained, the first in the form of zinc sulphate by evaporation and crystallisation, and the second in the form of zinc cathodes by electrodeposition;
8) flotation, where in this step hematite is separated from lead oxides and various metal oxides in a very small amount, such as, for example, cadmium, nickel, arsenic oxides; the solid coming from the leaching phase is insoluble under normal conditions, with a majority composition of hematite and with the minority presence of lead oxides, calcium sulphate (gypsum) and a presence of silver;
9) magnetic separation, where in this step the hematite still contains gypsum (CaSO4.2H₂O), where the gypsum must be separated from the hematite due to the need to use reduced hematite (Fe^{O}) as electric arc furnace feed material, in order to remove the gypsum, for which magnetic separation is used, taking advantage of the wide delta of magnetic susceptibility existing between hematite (35×10³ SI) and gypsum (−0.11×10³ SI), at low speeds between 0.7 feet/min and 0.8 feet/min of the magnetic separator and at a magnetic flux density between 19,000 gauss and 21,000 gauss;
10) a gas recovery system, where the method comprises in this step a conventional catalytic system for SO₃/SO₂ recovery, capturing gases in diluted solutions of H₂SO₄ (at 70%) in the presence of catalysts, the capture solution is added to the sulphuric acid stock of the method, the conventional catalytic system having forced air heat sinks and being encapsulated.
11) gas scrubbing system, where the system gases are essentially air, O₂ and CO₂; however, given the ultrafine nature of the dust, a small portion of said dust is entrained by the streams of said dust, forcing the gas and particles to pass through water mist and sprays under countercurrent (1.2 m³ per m³ of gas), repeatedly, with several scrubbing columns and coils, with the gas passing through ultrafine filters before leaving the method so as to ensure that there is no loss of solids;
12) recovery of sludge from the collector, where the loss of dust because of its ultrafine nature is prevented in this step, by handling sludge from these particles from all the reactors and flow systems which are encapsulated and capture fugitive particles which, because the various systems are in a closed circuit, finally produce sludge, as well as of water vapour which also entrains a minimum portion of particles, which are captured in the vacuum evaporation system and sent to the sludge collector; this sludge is filtered by two twin pumps with phenolic resin membranes at a pressure of 3.5 bar, the first with a 5-micron membrane and the second with a 2.5-micron membrane; and
13) liquid purification with a water decontamination unit which receives liquid flows containing anions, cations, suspension of ultrafine solid particles from the dust scrubbing method, gas scrubbing method, sludge collector and liquid flows of the flotation phase (concentrate and tailings) and eventually from the cleaning and maintenance method for any reactor, and includes a chemical ion separation system, high-pressure membrane filtration, vacuum evaporation, returning the clean water to the industrial condensed water method, crystallising the contaminants; the solids are integrated (precipitates, sludge and crystals), homogenised and added to the concentrate of lead/silver for the respective marketing thereof.

2. The hydrometallurgical method according to claim 1, wherein step 1) determines the zinc (12% to 35%) and iron (17.26% to 28.26%) grade, in addition to knowing with certainty the content of Cl, Pb, Ca, Ag, Cd and Hg.

3. The hydrometallurgical method according to claim 1, wherein in step 2) a reduction of Cl of more than 95% is obtained, consequently, very high reductions of Na, Mg, Ba are obtained, generally obtaining an average reduction of the 17% by weight of the initial content of dust (depending on the elemental contents in each specific case).

4. The hydrometallurgical method according to claim 1, wherein step 3) lasts for 20 minutes, and vigorous and constant mixing is required, because the paste formed is very viscous, and a complete chemical sulphation reaction and depletion of sulphuric acid must be obtained, so that no free acid solutions are generated in the method.

5. The hydrometallurgical method according to claim 4, wherein step 3) produces no liquids in any form, produces water vapour in a very limited form and very little acid mist, where these vapours and gases go to SO₂/SO₃ recovery systems and re-enter the sulphuric acid stock system of the closed circuit method.

6. The hydrometallurgical method according to claim 4, wherein in step 3), the oxide molecules are broken down, replacing the oxygen in the molecules with the typical compound SO₄.

7. The hydrometallurgical method according to claim 1, wherein step 4) lasts for about 10 minutes and allows for the removal of water to prevent thermal shock in the next step and to ensure the complete reaction of the new sulfide complex.

8. The hydrometallurgical method according to claim 1, Wherein in step 5), the thermolysis reaction (thermal decomposition) of iron sulphate takes place as the main reaction, which produces the formation of hematite, with the corresponding generation of SO2 and O2, according to the reaction: 4FeSO₄=2Fe₂O₃+O₂+4SO₂.

9. The hydrometallurgical method according to claim 8, wherein the reaction is carried out at normal pressure, the generated gases are sent to the gas cleaning and SO₂ capture system, which is added to the sulphuric acid stock of the method, in addition to the thermal decomposition reaction of the iron, where the oxides with lower formation energy in relation to iron are also decomposed, as in the case of Pb, Ag, Si, Mn, P, Sn, Cd, Ni, Bi.

10. The hydrometallurgical method according to claim 8, wherein the hematite formed and all the additional oxides formed are insoluble, while, in contrast, zinc in the form of sulphate has a high solubility, which is sent to an encapsulated hopper and cooled to 70° C.

11. The hydrometallurgical method according to claim 1, wherein in step 6), the leaching water comes from the condensed water system, which is a countercurrent system, such that the solids are solubilised and progressively lose zinc, whereas the solution progressively increases in terms of the content of zinc and, to a lesser extent, in terms of the content of Mn and Ca.

12. The hydrometallurgical method according to claim 11, wherein the water leachate does not contain any type of reactive chemical, which prevents the water leachate from being soluble in the solid essentially made up of hematite, and replaces the water losses due to evaporation.

13. The hydrometallurgical method according to claim 11, wherein the aqueous leaching phase produces the extraction of zinc, producing a solution which, on average, tests 56 g of Zn per litre, with a small amount of other components, where the solids are, for the most part, hematite and other metal oxides such as calcium and lead oxides.

14. The hydrometallurgical method according to claim 13, wherein the solids are very fine and a high-pressure pump filtration system provides an efficient separation of the leached solution, generating two new complexes, one being liquid with a large amount of zinc and the other one essentially made up of hematite, gypsum and lead oxides plus other minor oxides, which are sent to the flotation method, and the liquids are sent to the zinc recovery system (evaporation-crystallisation/electrodeposition), configured to keep the temperature of the liquid flow at 70° C., which is moved by peristaltic impulse.

15. The hydrometallurgical method according to claim 1, wherein, in step 7 (Zn recovery), zinc sulphate is produced, and the liquid containing essentially zinc is previously vacuum-evaporated, this operation being performed in a conventional vacuum evaporator wherein the volume of water is reduced by 96%, sending the water vapour to the condensation system, from where the water is recycled to the various water needs of the method.

16. The hydrometallurgical method according to claim 1, wherein the evaporation method prevents the metal and non-metal ions from leaving the solution, the water vapours do not contain ions, and as the volume of liquid water is reduced, the concentration of zinc increases.

17. The hydrometallurgical method according to claim 15, wherein for producing zinc sulphate, an oversaturated solution of 1,800 g Zn/L is produced, which solution enters the crystallisation method in steps and in countercurrent in the conventional encapsulated reactor with a temperature delta of 40° C.; the first crystals are very pure, and the last crystals that are formed are less pure, which finally produces the crystalliser in a mixture of all these crystals.

18. The hydrometallurgical method according to claim 1, wherein, in step 7 (Zn recovery) zinc cathodes are obtained, for which a subsaturated solution is produced with 60 grams per litre of zinc for the zinc electrodeposition method, by the conventional zinc cathode electrodeposition method from sulphuric solutions.

19. The hydrometallurgical method according to claim 1, wherein the liquids are recycled by vacuum evaporation, and the anode sludge is added to the concentrate of lead-silver.

20. The hydrometallurgical method according to claim 1, wherein in step 8), by using the flotation properties of the lead and silver oxides in the presence of hematite (absence of sulfides), foam flotation operations produce an ore concentrate of commercial-quality lead-silver, and additionally cleans the hematite of heavy metal oxides.

21. The hydrometallurgical method according to claim 1, wherein due to the ultrafine nature of the particles of all the components, flotation is a virtually artisanal operation that takes two hours, a time that favours the entrainment of lead oxides and heavy metal oxides, using as flotation reagents those from the family of sodium sulfide (Na₂S), in the presence of sodium carbonate and sodium silicate, with the use of xanthate and pine oil, with the hematite additionally needing starch as a depressant.

22. The hydrometallurgical method according to claim 1, wherein step 9) uses magnetic separation steps from lower to higher flux density, obtaining pre-concentrates of hematite which are subsequently mixed in order to be sent to the hematite reduction method in their conventional form to produce reduced iron, which is agglomerated due to its fine nature to finally be returned to the electric arc furnace.

23. The hydrometallurgical method according to claim 1, wherein in step 11), the solids are captured as sludge which is, in essence, electric arc furnace dust or calcine from the thermolysis method, this sludge is sent to the sludge collection system, and the liquid from the gas scrubbing method is sent to the liquid purification unit by impulsion by peristaltic pumps.

24. The hydrometallurgical method according to claim 1, wherein in step 12), the obtained solids are added to the concentrate of lead/silver, thereby preventing the generation of waste, an operation that does not affect the quality of the concentrate, and the resulting liquid has an ionic content, and is sent to the liquid purification unit.

25. The hydrometallurgical method according to claim 1, wherein due to the corrosive nature of the liquids, the agitation systems of the tanks and the line pipes have an anticorrosive coating; and the liquid and pulp impulsion systems are carried out by peristaltic pumps.

26. The hydrometallurgical method according to claim 1, wherein the filtered solids have, on average, 8% humidity, are insoluble solids, and are almost entirely made up of complex metal oxides.
